(19) United States
(12) Patent Application Publication
(10) Pub. No.: US 2024/0220957 A1
(43) Pub. Date: Jul. 4, 2024

(54) LOCALIZING PRODUCTS WITHIN IMAGES USING IMAGE SEGMENTATION.

(71) Applicant: Target Brands, Inc., Minneapolis, MN (US)

(72) Inventors: Arun Patil, Bengaluru (IN); Ashok Jayasheela, Bengaluru (IN); Arun Vaishnav, Bengaluru (IN); Kumar Abhishek, Bengaluru (IN); Spoorti Nayak, Bengaluru (IN); Dharmavaram Arbaaz, Bengaluru (IN)

(21) Appl. No.: 18/142,393

(22) Filed: May 2, 2023

(30) Foreign Application Priority Data
Jan. 4, 2023 (IN) 202311000684

(51) Int. Cl. G06Q 20/20; G06T 7/194; G06T 7/20; G06T 7/70; G06V 10/25; G06V 40/10

(52) U.S. Cl. CPC G06Q 20/208; G06T 7/194; G06T 7/20; G06T 7/70; G06V 10/25; G06V 40/10; G06V 2201/07

(57) ABSTRACT

The present disclosure is directed to an artificial intelligence (AI) assisted monitoring system that uses cameras to recognize a product being moved by the user across the self-checkout unit and verifying whether the product was scanned at the point-of-sale terminal based on timestamp information associated with when the product was moved across the self-checkout unit to identify miss scan thefts.

### BACKGROUND

Self-checkout units are widely prevalent within stores. Self-checkout units provide users with the ability to scan and pay for products on their own without the help of a store employee. However, stores typically have to spend resources to monitor the activities at the self-checkout unit in order to prevent theft. Generally, stores may employ one or more employees to stay near the self-checkout unit to monitor the user's activities and catch common theft techniques. However, having an employee continuously monitoring the user's actions may cause unease and be intrusive to the user while also being costly for the store. Therefore, there exists a need for a non-intrusive technique to identify theft.

### SUMMARY

Examples provided herein are directed to image segmentation to extract pixels associated with a product.

According to one aspect, a method to localize a product within one or more images is disclose. The method including: receiving the one or more images from an imaging device; identifying one or more background objects and one or more foreground objects within each of the one or more images using a background detection learning model; identifying one or more body parts within the one or more foreground objects within each of the one or more images using a trained body part segmentation model; identifying pixels associated with the product within each of the one or more images by segmenting out the one or more background objects and the one or more body parts from each of the one or more images; and creating a localized product within each of the one or more image by enclosing the pixels associated with the product within each of the one or more images with an outline.

According to another aspect, a system to localize a product within one or more images is disclosed. The system comprising: an imaging device; a computing system comprising: a processor; a memory communicatively connected to the processor which stores program instructions executable by the processor, wherein, when executed the program instructions cause the system to: receive the one or more images from the imaging device; identify one or more background objects and one or more foreground objects within each of the one or more images using a background detection learning model; identify one or more body parts within the one or more foreground objects within each of the one or more images using a trained body part segmentation model; identify pixels associated with the product within each of the one or more images by segmenting out the one or more background objects and the one or more body parts from each of the one or more images; and create a localized product within each of the one or more image by enclosing the pixels associated with the product within each of the one or more images with an outline.

According to yet another aspect, a system to detect a miss scan theft is disclosed. The system comprising: a self-checkout unit comprising: a flatbed area; a point-of-sale terminal; an imaging device; and a computing system comprising: a processor; a memory communicatively connected to the processor which stores program instructions executable by the processor, wherein, when executed the program instructions cause the system to: receive one or more images from the imaging device; identify one or more background objects and one or more foreground objects within each of the one or more images using a background detection learning model; identify one or more body parts within the one or more foreground objects within each of the one or more images using a trained body part segmentation model; identify pixels associated with a product within each of the one or more images by segmenting out the one or more background objects and the one or more body parts from each of the one or more images; create a localized product within each of the one or more image by enclosing the pixels associated with the product within each of the one or more images with an outline; determine whether a user is performing a scanning action at the self-checkout unit by determining whether a position of the localized product among the one or more images moves from one side of the flatbed area of the self-checkout unit to another side of the flatbed area the self-checkout unit; upon determining that the user is performing the scanning action, estimate a time interval at which the user performs the scanning action; retrieve transaction data for the time interval from the point-of-sale terminal associated; determine whether a checkout transaction was recorded among the transaction data for the time interval; and upon determining that the checkout transaction was not recorded among the transaction data for the time interval, determine that a miss scan theft occurred.

The details of one or more techniques are set forth in the accompanying drawings and the description below. Other features, objects, and advantages of these techniques will be apparent from the description, drawings, and claims.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example checkout lane within a retail store environment.

FIG. 2 illustrates an example configuration of a miss scan detection system implemented within a retail environment using the components described in FIG. 1.

FIG. 3 illustrates an example configuration of the miss scan detection engine of FIG. 2.

FIG. 4 illustrates an example method of segmenting an image using the miss scan detection engine of FIG. 2.

FIG. 5 illustrates an example method of detecting miss scans at a checkout lane using the miss scan detection engine of FIG. 2.

FIG. 6 illustrates example physical components of the computing device of FIGS. 1-2.

### DETAILED DESCRIPTION

This disclosure relates to segmentation of an image to localize pixels associated with a product within the image.

Self-checkout units within stores provide users with the ability to scan and pay for products on their own and without the help of a store employee. However, stores typically have to spend resources to monitor the activities at the self-checkout unit in order to prevent theft. For example, two common ways theft occurs at the self-checkout unit include ticket switching and miss scans. Ticket switching consists of a user occluding the bar code of a cheaper product onto a much more expensive product and scanning the barcode of the cheaper product at the self-checkout counter. Miss scan consists of a user simulating the action of scanning a product at the self-checkout unit while avoiding scanning the real barcode of the product so that from the point of view of an observer it seems that the product is being scanned while in reality the user is not being billed for the product.

The present disclosure is directed to an artificial intelligence (AI) assisted monitoring system that uses cameras to recognize a product being moved by the user across the self-checkout unit and verifying whether the product was scanned at the point-of-sale terminal based on timestamp information associated with when the product was moved across the self-checkout unit to identify miss scan thefts.

A first step in identifying the product being moved across the self-checkout unit, include detecting and localizing pixels within one or more image frames of the camera as belonging to the product itself. One example method of detecting or localizing pixels within one or more image frames of the camera as belonging to a product may include training a convolutional neural network (CNN) model for different products stocked by the store. However, training a CNN model for the products themselves may not scale well for new products or when product packaging changes, thus requiring repeated training and fine-tuning.

The disclosed system and method leverage fixed background within the image and an understanding of the forearm and/or hand position/motion during the checkout process in order to localize the pixels belonging to the product within a camera image. For example, image frames from one or more fixed cameras associated with the self-checkout unit that include pixels of the product visibly being moved across the flatbed area of the self-checkout unit are first selected. For each of the selected image frames, the pixels associated with the product may be isolated by first isolating the foreground objects from the background objects, then segmenting the foreground objects into pixels associated with the product and pixels associated with user body parts including forearms and hands and eliminating the pixels belonging to the user body parts from the image.

For example, a background modeling algorithm may be used to analyze each of the selected image frames from the camera associated with the self-checkout unit to identify the background objects and foreground objects within the image frame. Background objects may include static objects within the image that do not move or change over a period of time. For example, in case of images taken by a camera mounted over the flatbed area of a self-checkout unit, the background image may include one or more of: an empty flatbed area, a display monitor, the hand held scanner, the basket are where the user may choose to set their baskets, the carry-out bag area, the floor and/or portions of the shelves adjacent to the self-checkout unit. In one example, a background model algorithm, such as Mixture of Gaussians 2 (MOG2) model may be used to isolate the background objects within each of the image frames from the fixed cameras associated with the self-checkout unit. In other examples, other types of background algorithms may also be used. The foreground objects within the image may be identified by eliminating the pixels associated with the detected background objects.

In some examples, the identified foreground objects may further be refined by only focusing on foreground objects within the flatbed area of the self-checkout unit. Thus, the foreground objects positioned only over the flatbed area of the self-checkout unit may be extracted and used to further perform additional segmentation processes to extract the product pixels within the image frames.

The pixels associated with the product may be isolated from the foreground objects by eliminating any pixels among the foreground object that belongs to the forearms, hands or other body parts of the user. For example, a video object segmentation (VOS) model may be used to detect and segment out the user's body parts from the foreground objects of the image frames. A VOS model may initially be trained using manually annotated images. For example, images with different portions of hands, fingers, forearms, and other body parts may be manually annotated to identify the outline of the body parts and the object and used to initially train the VOS model. Additional training images may include body parts with tattoos, jewelry, gloves, hands holding cellphones, wallets or other objects, etc. Once trained with a plurality of manually annotated images, the VOS model may automatically identify and segment out body parts such as hands, forearms, fingers, etc. that appear within the extracted foreground objects positioned within the flatbed area of the self-checkout unit, thus leaving only the pixels associated with the product. A tight outline may be added to highlight the outline of the product within the image frames in order to assist with the next steps of the process, which includes identifying potential ticket switching or miss scan incidents.

Once the product is segmented using a combination of background modeling and image segmentation algorithms, ticket switching incidents may be identified based on one or a combination of: (i) product dimensions and/or (ii) product embeddings.

For example, the outline highlighting the product's outline on each of the image frames may be used to calculate the dimensions of the product moved across the self-checkout unit as seen across each of the image frames. The dimensions may be calculated based on the dimensions of the flatbed itself. For example, based on the assumption that the products moved across the flatbed area are likely to be held close to the flatbed area itself in order to engage the scanner integrated into the flatbed area, the dimensions of the product may be estimated based on the products dimensions relative to the known dimensions of the flatbed area. Additionally, the dimensions of the scanned product may also be retrieved from a data store containing parameters associated with the product. If the calculated dimensions from at least one of the image frames match the dimensions of the scanned products, then the product is considered to match the scanned product and no ticket switching theft is identified. Alternatively, if the calculated dimensions from none of the image frames match the dimensions of the scanned products, then the product is considered to not match the scanned product and the transaction is flagged as potentially including a ticket switching theft.

In addition, the outline highlighting the product's boundary on each of the image frames may also be used to extract feature embeddings associated with the product image. A feature embedding includes a vector representation of features of the image. The feature embeddings of the scanned product may also be retrieved from a data store that stores feature embeddings of the scanned product based on various accurate scans. If the feature embeddings from at least one of the image frames matches at least one of the feature embeddings of the scanned products, then the product is considered to match the scanned product and no ticket switching theft is identified. Alternatively, if the feature embeddings from none of the image frames match none of the feature embeddings associated with the scanned product, then the product is considered to not match the scanned product and the transaction is flagged as potentially including a ticket switching theft.

Additionally, once the product is segmented using a combination of background modeling and image segmentation algorithms, miss scan incidents may also be identified using time stamp information. For example, the segmentation of body parts within image frames as the product is moved across the flatbed area of the self-checkout unit can be used to detect that the user has performed a product checkout transaction. The timestamp associated with such a user action may be determined and used to check whether a transaction was in fact conducted at the self-checkout unit during the same time as the timestamp. If a transaction was in fact recorded as being conducted at the same time as the determined timestamp, then it may be determined that a miss scan theft did not take place and further actions, such as verification for ticket switching incidents may be performed. Otherwise, if a transaction was not recorded as being conducted at the same time as the determined timestamp, then a miss scan theft may be identified.

While the localizing of product pixel using background imaging and segmentation of body parts is discussed herein in relation to identifying ticket scan and miss scan thefts, the disclosed image segmentation system and process may be used to isolate products within image in other contexts such as detecting out of stocks within store shelves when the products are obscured by carts, baskets, persons etc. as well. Other applications of the disclosed image segmentation system and process is also possible.

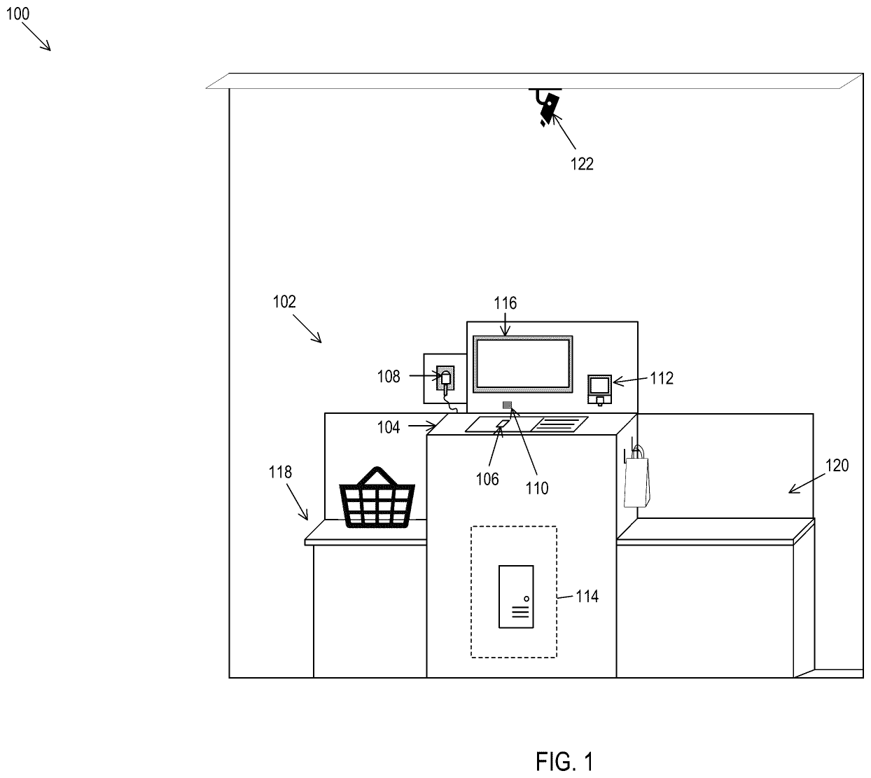

FIG. 1 illustrates an example checkout lane 100 within a retail store environment. The example checkout lane 100 may include a self-checkout unit 102 and one or more overhead imaging devices 122 mounted above the self-checkout unit 102 to overlook portions of the self-checkout unit 102. The self-checkout unit 102 may include a flatbed area 104, one or more scanning devices 106, a handheld scanning device 108, one or more imaging devices 110, a point of sale (POS) terminal 112, a computing device 114 including a display screen 116, a basket area 118 and a bagging area 120. A retail environment can include multiple checkout lanes 100 that each include a self-checkout unit 102 that users can use to go through a self-checkout process.

The flatbed area 104 of the self-checkout unit 102 is a flat portion of the self-checkout unit that may include one or more integrated scanning devices 106. The one or more scanning devices 106 can include a barcode, SKU, or other label identifying devices. The scanning devices 106 can also be LiDAR, infrared, and one or more other types of scanning devices and/or flatbed scanners. The one or more scanning devices 106 may be used to scan the barcode, or other visual identifiers, attached to the product in order to purchase the product.

The self-checkout unit 102 may also include a handheld scanning device 108 that the user can direct towards a label, such as a barcode, attached to a product that the user is purchasing in order to scan the label as part of the self-checkout process.

One or more imaging devices 110 may also be integrated into the flatbed area 104 and/or positioned adjacent to the flatbed area 104 such that the imaging devices 110 may capture images of the products as the user proceeds through a self-checkout process. The images captured by the imaging devices 110 can be used, as described further below, to identify products that are being purchased by the user. Such images can also be used to train and/or improve one or more machine learning models that can be used to identify the products. In addition to the one or more imaging devices 110, as described below, the checkout lane 100 may also include one or more overhead imaging devices 122 to capture images of the products as the products as the user proceeds through the self-checkout process.

The POS terminal 112 can be configured to identify products that are scanned using the one or more scanning devices 106 and/or handheld scanning device 108. For example, the POS terminal 112 can receive a scan of a product label from the one or more scanning devices 106 and/or handheld scanning device 108. Using the scan of the product label, the POS terminal 112 can determine a price of the product associated with the label. The POS terminal 112 can then add the determined price to the user's bill (e.g., transaction, receipt).

The computing device 114 can include a display screen 116. The display screen 116 can output information about the user's transaction. For example, the display screen 116 can output scanned products and their associated prices in real time, as the user scans the products. The display screen 116 can also be a touchscreen. The user can, for example, input information at the display screen 116 about products being purchased, such as a quantity and/or weight of such products. The user can also use the display screen 116 to look up products that the user is purchasing (e.g., fresh produce that may not have barcodes or other identifying labels attached to them). When the user is done scanning products, the user can complete their purchase by paying at the POS terminal 112.

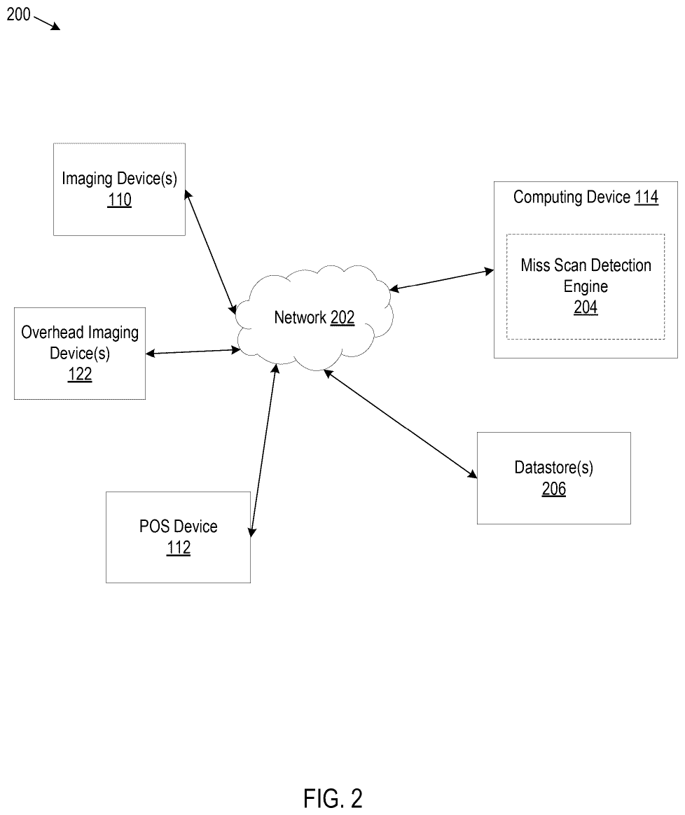

The computing device 114, the POS terminal 112, and the display screen 116 can be part of the same or separate devices. For example, the POS terminal 112 can be integrated with the display screen 116. In another example, the display screen 116 can be separate from the computing device 114. In a further example, the display screen 116 can be separate from both the POS terminal 112 and the computing device 114. In some examples, the computing device 114 may be located adjacent to or within the self-checkout unit 102. In other examples, the computing device 114 may be located within the same retail store environment as the checkout lane 100. Other configurations are also possible. The computing device 114 is described in further detail in relation to FIG. 2.

For example, the computing system 114 can be configured to make real-time determinations of product identification. As described herein, in some examples, the computing device 114 can deploy one or more machine learning models to identify a product from image data that is captured by the one or more imaging devices 110 and/or the overhead imaging device 108 at the checkout lane 100. In other examples, the computing device 122 can be communicatively connected to a remote server computing device (not shown) that can deploy one or more machine learning models to identify a product from image data upon receiving the image data captured by the one or more imaging devices 110 and/or the overhead imaging device 122 at the checkout lane 100. The computing device 114 can therefore quickly and accurately determine whether a product is being scanned by the user and capture clean images of the product for further processing.

In some examples, the self-checkout unit 102 may include a basket area 118 and/or a bagging area 120. The basket area 118 may provide a space for the user to place their shopping basket before the products are checked out using the one or more scanners 106 or the handheld scanner 108 at the flatbed area 104. The bagging area 120 may provide a space for the user to place the products in one or more bags or containers after the products are checked out.

The overhead imaging device 122 can be a high-resolution camera. The overhead imaging device 122 may be attached to the ceiling or a pole or fixture such that the position of the overhead imaging device remains fixed and unchanged. For example, the overhead imaging device 122 can have 1920×1080 resolution. The overhead imaging device 122 can be configured to capture images of products as they are scanned by the one or more scanning devices 106 and/or handheld scanning device 108 or otherwise passed over the flatbed area 104. These images can be used for identifying a product that the user is purchasing in real-time. Moreover, these images can be used to build a robust image training dataset that can be used to train and improve one or more machine learning models used for product identification.

As mentioned throughout this disclosure, each checkout lane 100 in each retail environment can have the same configuration of the overhead imaging device 122 attached to the ceiling or a fixture. Therefore, images captured by any overhead imaging device 122 at any checkout lane 100 can have uniform field of view (FOV) and lighting. Such consistent image data can be beneficial to train machine learning models to more accurately identify products from the image data, as will be described further below. For example, with consistent FOV and lighting, features of a product can be more clearly differentiated from an ambient environment in the image data. These features can be labeled, and confidence of such labeling can increase since the image data can be associated with a timestamp of a correct barcode scan at the POS terminal 112.

A typical checkout process at the checkout lane 100 may be initiated when a user can place a shopping basket at the basket area 118 or a shopping cart next to the checkout lane 100. The checkout process includes a user removing products from the basket or cart and passing such products over the flatbed area 104. The flatbed area 104 can include the one or more scanning devices 106, which can be configured to scan images of product labels, such as barcodes on the product. Thus, the user can scan the product's barcode at the POS terminal 112 using the one or more scanning devices 106.

When a scan of a product is completed, the POS terminal 112 can identify the product associated with the scanned barcode. For example, the POS terminal 112 can look up, in a data store, a product that corresponds to the scanned barcode. Once the product associated with the barcode is identified, the POS terminal 112 can update the user's bill with a price of the associated product. The updated bill can be outputted on the display screen 116.

The user can continue scanning barcodes or other product labels until the basket or cart is empty. The POS terminal 112 can transmit the product identifications to the computing device 114. For example, the POS terminal 112 can transmit all the product identifications once all the products are scanned and identified. In another example, the POS terminal 112 can transmit the product identifications as they are made in real-time. Other configurations are also possible.

FIG. 2 illustrates an example configuration of a miss scan detection system 200 implemented within a retail environment using the components described in FIG. 1. The example miss scan detection system 200 may be configured to detect theft of product in retail environments due to miss scans. Miss scan consists of a user simulating the action of scanning a product at the self-checkout unit while avoiding scanning the real barcode of the product so that from the point of view of an observer it seems that the product is being scanned while in reality the user is not being billed for the product.

The miss scan detection system 200 includes one or more imaging devices 110, one or more overhead imaging devices 122, a POS terminal 112, a computing device 114, a network 202, and one or more data stores 206. The one or more imaging devices 110, the one or more overhead imaging devices 122, the POS terminal 112 and the computing device 114 may be associated with a self-checkout unit 102 at checkout lane 100 of a retail store environment and are described in detail in relation to FIG. 1.

As described above in relation to FIG. 1, in some examples, the computing device 114 may be located adjacent to or within the self-checkout unit 102 itself. In other examples, the computing device 114 may be located within the same retail store environment as the checkout lane 100 and may be connected to the one or more imaging devices 110, the one or more overhead imaging devices 122, the POS terminal 112 and display screen 116 via the network 202. In some examples, the network 202 is a computer network, such as the Internet, a WiFi network, or a Bluetooth network. The network 202 may include other types of networks as well.

The computing system 114 may be a server computer of an enterprise or organization that is a retailer of goods. However, the computing system 114 may include server computers of other types of enterprises as well. Although a single computing system is shown in FIGS. 1 and 2, in reality, the computing system 114 can be implemented with multiple computing devices, such as a server farm or through cloud computing. Many other configurations are possible. In some examples, the computing system 114 may be located at a central server that is located away from the retail store location. In other examples, the computing system 114 may be located at the retail store location itself.

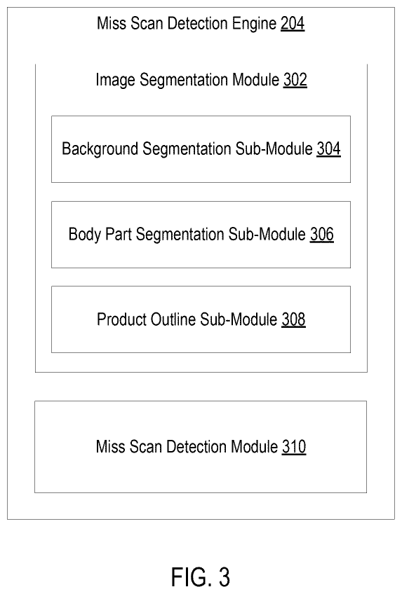

The computing device 114 may include a miss scan detection engine 204 that may be configured to detect miss scan incidents using image segmentation techniques discussed herein. The configuration of the miss scan detection engine 204 is described further in relation to FIGS. 3-6.

The example datastore(s) 206 may include one or more electronic databases that can store one or more data tables that includes data associated with the entity and the products carried by the entity. The miss scan detection engine 204 may store and retrieve data in the datastore(s) 206 via the network 202. The datastore 206 may be maintained by the entity or organization itself or be maintained by one or more external, third-parties associated with the entity. The datastore 206 can be accessed by the computing system 114 to retrieve relevant data.

FIG. 3 illustrates an example configuration of the miss scan detection engine 204 of FIG. 2. The miss scan detection engine 204 may be configured to include an image segmentation module 302 and a miss scan detection module 310.

The image segmentation module 302 may be configured to receive one or more image frames from the one or more imaging devices 110 and/or the overhead imaging device 122. In one example, the one or more image frames may be extracted from a video captured by the one or more imaging devices 110 and/or the overhead imaging device 122 as the user passes a product across the flatbed area of the self-checkout unit 102. In another example, the one or more image frames may be captured as images by the one or more imaging devices 110 and/or the overhead imaging device 122 as the user passes a product across the flatbed area of the self-checkout unit 102. The one or more images may each be associated with a time stamp that correlates to the time at which the image was captured.

Each of the received images may include background objects and foreground objects. Background objects may include static objects within the image that do not move or change over a period of time. For example, the images captured by the overhead imaging device 122 may include one or more of: the empty flatbed area 104, the display screen 116, the handheld scanning device 108, the basket area 118 are where the user may choose to set their baskets, the bagging area 120, the floor and/or portions of the shelves adjacent to the self-checkout unit 102.

The foreground objects may include the product that is being moved across the flatbed area 104 and one or more other objects adjacent to the product, such as body parts of the user. For example, the one or more other objects may include the user's forearm(s), hand(s) and/or finger(s). In some examples, any object that is not identified to be a background object, may be determined to be a foreground object.

The image segmentation module 302 may be configured to segment the pixels associated with the product from the rest of the image. In one example, the image segmentation module 302 may first segment the foreground objects from the background objects and upon isolating the foreground objects, further segment the image of the product from the foreground objects in order to arrive at the localized image of the product.

The image segmentation module 302 may include a background segmentation sub-module 304, a body part segmentation sub-module 306 and a product outline sub-module 308. The background segmentation sub-module 304 may be configured to isolate one or more background objects from the foreground objects. The background object may be identified using a continuously learning background modeling algorithm.

The background modeling algorithm may be configured to adapt to a changing environment to automatically learn a distinction between background and foreground objects within captured image frames. Experimenting with different background algorithms has shown that applying a gradient background modeling algorithm to a red-green-blue (RGB) image that has been processed to identify the gradients within the image yields better detection of background objects than simply applying a RGB background modeling algorithm to the red-green-blue (RGB) image. Thus, in some examples, the images from the one or more imaging devices 110 and/or the overhead imaging device 122 may be pre-processed with a gradient detector to identify the gradients within the image and a gradient background modeling algorithm may be applied to the gradient detected image.

In addition to the gradient detector, the images from the one or more imaging devices 110 and/or the overhead imaging device 122 may also be pre-processed to remove shadows before applying the background modeling algorithm. For example, when a product is moved across the flatbed area 104, the metal and glass surface of the flatbed area 104 may display reflections of the product. Typically, the pixels associated with a reflection may be darker and have higher pixel values than pixels displaying an object itself. Thus, any pixel within the flatbed area 104 of the self-checkout unit 102 may be analyzed to detect and eliminate pixels considered to be reflections during the pre-processing of the image before the background modeling algorithm is applied.

In some examples, a background modeling algorithm, such as Mixture of Gaussians 2 (MOG2) model may be used to isolate the background objects within each of the image frames received from the one or more imaging devices 110 and/or the overhead imaging device 122. In other examples, other types of background algorithms may also be used.

Once the background modeling algorithm identifies the background objects within the one or more image frames received from, the background segmentation sub-module 304 may segment the background objects from the one or more images such that the one or more image frames only include the foreground objects.

The body part segmentation sub-module 306 is configured to receive the foreground objects as determined by the background segmentation sub-module 204 and to localize the product image within the one or images by detecting and removing body parts of persons within the foreground objects.

In one example, a video object segmentation (VOS) model may be used by the body part segmentation sub-module 306 to detect and segment out the body parts associated with the user or one or more other persons from the foreground objects of the image frames. In other examples, another type of object segmentation model may be used to localize the product image from other types of common foreground objects such one or more of: as at least a portion of a shopping basket, at least a portion of a shopping cart, a cellular telephone, a purse, a wallet, or at least a portion of clothing associated with the user.

In some examples, the object segmentation model may be trained using manually annotated images. For example, images with different portions of hands, fingers, forearms, and other body parts may be manually annotated to identify the outline of the body parts and the object and used to initially train the object segmentation model. Additional training images may include body parts with tattoos, jewelry, gloves, hands holding cellphones, wallets or other objects, etc. Once trained with a plurality of manually annotated images, the object segmentation model may automatically identify and segment out body parts such as hands, forearms, fingers, etc that appear within the extracted foreground objects positioned within the flatbed area 104 of the self-checkout unit 102, thus leaving only the pixels associated with the product.

The product outline sub-module 308 may be configured to receive the localized product image from each of the one or more image frames received from the one or more imaging devices 110 and/or the overhead imaging device 122 and perform a morphological operation to include a dense outline tightly enclosing the borders of the product image. Bounding the localized product image allows for easy detection of features associated with the product, such as size, shape, color, etc.

The miss scan detection module 310 may be configured to receive the one or images with the product image enclosed within a dense outline from the one or more imaging devices 110 and/or the overhead imaging device 122 and the time stamp associated with each of the images from the product outline sub-module 308. The miss scan detection module 310 may use the received image data to analyze whether a product was moved across the flatbed area 104 of the self-checkout unit 102. For example, the miss scan detection module 310 may organize the one or more images with the product image enclosed within a dense outline received from the product outline sub-module 308 based on the received time stamp information. The miss scan detection module 310 may then determine whether a product was moved across the flatbed area of the self-checkout unit 102 as the time stamp increases associated with the one or more images increases. For example, the miss scan detection module 310 may determine whether the position of the product enclosed by the product outline within the one or more images moves in a particular direction in relation to the flatbed area 104 of the self-checkout unit 102. Upon determining that the position of the detected product moves across the flatbed area 104 of the self-checkout unit 102 as the time stamp associated with the images increases, the miss scan detection module 310 may determine that a scanning action performed by the user.

The miss scan detection module 310 may determine the time at which the product may have been potentially scanned by the one or more scanning devices 106 based on the time stamp information associate with the images when the product position within the one or more images is above the flatbed area 104 of the self-checkout unit 102. The determined time is identified by the miss scan detection module 310 to be the estimated time at which the product should have been scanned by the user. The estimated time may include a single time or a range of time. The miss scan detection module 310 may request and receive the records from the POS terminal 112 for the estimated time at which the product should have been scanned by the user.

If the received records from the POS terminal 112 includes a checkout transaction that occurred during the estimated time from the received records from the POS terminal 112, the miss scan detection module 310 may determine that no miss scan theft occurred. Alternatively, if the received records from the POS terminal 112 does not include any checkout transactions that occurred during the estimated time from the received records from the POS terminal 112, the miss scan detection module 310 may determine that a miss scan theft may have occurred.

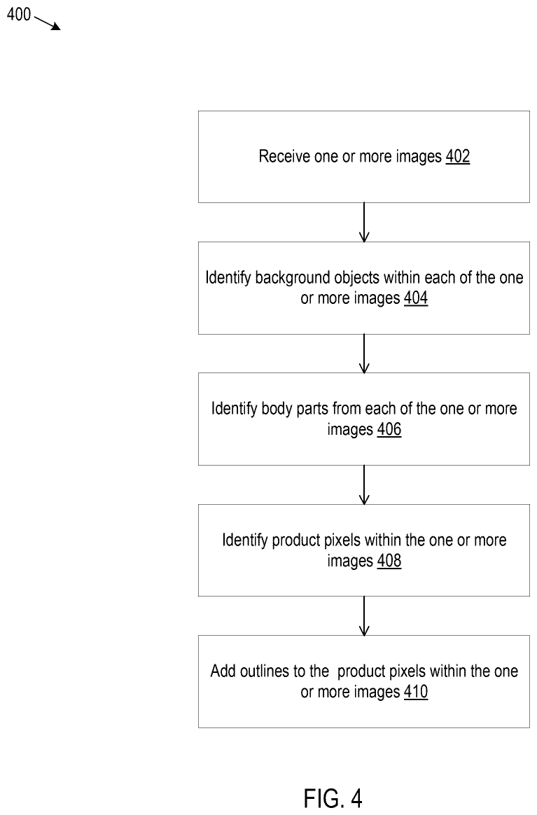

FIG. 4 illustrates an example method 400 of segmenting an image to localize a product within the image by an image segmentation module 302 as described in FIG. 3. Although the example method 400 is described in relation to segmenting one or more images to localize a product within the one or more image, the one or more images may all be associate with a single scanning event. A scanning event may correspond to the moving of one product across the flatbed area 104 of the self-checkout unit 102. During a checkout process, a user may perform multiple scanning events, each event corresponding to each product in the user's shopping basket or shopping cart. The one or more imaging devices 110 and/or overhead image device 122 may capture one or more images associated with each scanning event. Each image within the one or more images associated with each scanning event may be processed by the image segmentation module 302 using the example operations of example method 400.

In example operation 402, the image segmentation module 302 of the miss scan detection engine 204 implemented on the computing device 114 may receive one or more images captured by the one or more imaging devices 110 and/or the overhead imaging device 122, wherein the one or more images are all associated with a single scanning event.

Each of the one or more images may be captured as images by the one or more imaging devices 110 and/or the overhead imaging device 122 or may be extracted from a video stream captured by the one or more imaging devices 110 and/or the overhead imaging device 122. The one or more images include a field of view that remains consistent over time due to the fixed positions of the imaging devices.

The one or more images may include background and foreground objects. The background objects include objects that remain static or unchanged over a certain amount of time. The background objects may include an empty flatbed area 104, a display screen 116, a handheld scanning device 108, a basket area 118 are where the user may choose to set their baskets, a bagging area 120, the floor and/or portions of the shelves adjacent to the self-checkout unit 102.

The foreground objects may include the body parts associated with a user, other persons accompanying the user, other persons within the general vicinity of checkout lane 100, the basket or cart filled with one or more products.

In example operation 404, the background segmentation sub-module 304 of the image segmentation module 302 may identify background objects within each of the one or more images. For example, as described above in relation to FIG. 3, the background segmentation sub-module 304 may use a continuously learning background modeling algorithm to identify background objects within the one or more images by identifying objects within the one or more images that remain static over a certain period of time. The background modeling algorithm may be trained and periodically tuned to learn the background objects within the field of view of the one or more imaging devices 110 and the overhead imaging device 122.

For example, identifying the background objects within each of the one or more images may include identifying all pixels within the one or more images that are identified as belonging to a background object by the continuously learning background modeling algorithm and identifying all pixels within the one or more images that are not identified as belonging to a background object as belonging to a foreground object.

In example operation 406, the body part segmentation sub-module 306 of the image segmentation module 302 may identify body parts associated with the user and/or one or more other persons that is visible among the foreground objects of the one or more images. For example, identifying body parts among the foreground objects of the one or more images include identifying all pixels among the one or more images that have been identified as a foreground object within the one or more images as belonging to a body part of a person. For example, the foreground objects within an image may include all objects that were not determined to be background objects. As further described above in relation to FIG. 3, the body part segmentation sub-module 306 may use a trained object segmentation model to identify body parts associated with the user or other persons that are present within the one or more images. In some examples, although only segmentation of body parts within the images is described in detail, different types of object segmentation models may be trained to identify and segment out commonly found objects present within the foreground objects of the one or more images as well.

In example operation 408, the background segmentation sub-module 304 of the image segmentation module 302 may segment out the identified background objects from the one or more images and the body part segmentation sub-module 306 of the image segmentation module 302 may segment out the identified body-parts of person and other foreign objects from the foreground objects in order to identify the pixels associated with only the product within the one or more images. For example, segmenting out the identified background objects from the one or more images and segmenting out the identified body-parts of persons and other foreign objects from the foreground objects may be achieved by selecting all pixels within the one or more images that are not identified to be one of the one or more background objects in operation 404 or one of the one or more body parts in operation 406.

In example operation 410, the product outline sub-module 308 may receive the one or more images with the identified product pixels from operation 408 and localize the product by adding a dense outline that encompasses the boundary of the localized object. Adding the outlines for the product in each of the one or more images may help distinguish the shape, size and position of the product within the image. The miss scan detection module 310 may use the outline product within each of the images and the time stamps associated with each of the images to further identify whether the product position moved from one side of the flatbed area 104 to another across a time interval to be classified as a scanning action.

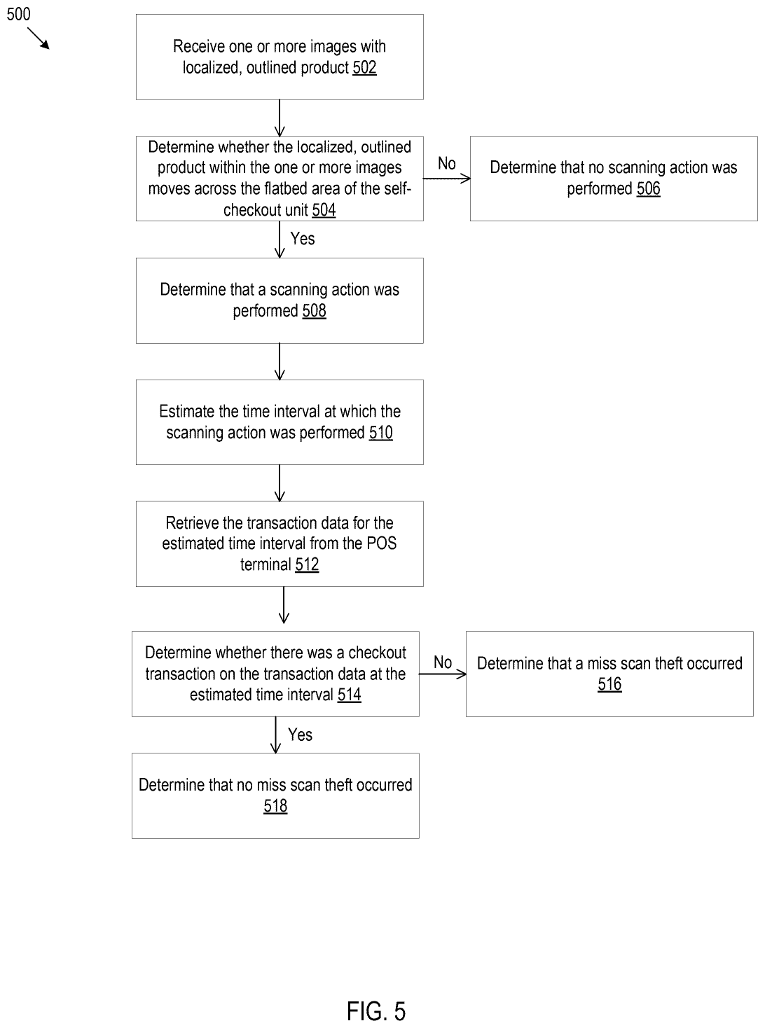

FIG. 5 illustrates an example method 500 of detecting miss scans at a checkout lane 100 using the miss scan detection engine from FIG. 2.

In example operation 502, the miss scan detection module 310 may receive one or more images with localized, outlined product from the from the product outline sub-module 308. For example, the one or more images with localized, outlined product may be produced by the product outline sub-module 308 as described in operation 410 of FIG. 4.

In example operation 504, the miss scan detection module 310 may determine whether the localized outlined product within the one or more images moves across the flatbed area 104 of the self-checkout unit 102 over a time interval. The movement of the localized outlined product across the flatbed area 104 of the self-checkout unit 102 may be used as a method for determining whether a scanning action associated with the product was performed by the user.

For example, the miss scan detection module 310 may organize the one or more images with the localized, outlined product based on ascending timestamps and determine whether the position of the localized product withing each of the images moves as the time stamp value increases and whether the movement of the position of the localized, outlined product within each of the images over a time interval is in a direction that extends from the basket area 118 towards the bagging area 120 of the self-checkout unit 102.

In a case where only one image was received from the one or more imaging devices 110 and/or overhead imaging device 122 in operation 402 and/or 502, a determination of whether the localized, outlined product may be made based on whether the localized, outlined product is positioned adjacent or on top of the flatbed area 104 of the self-checkout unit 102 in the received image. If the localized, outlined product is positioned adjacent or on top of the flatbed area 104 of the self-checkout unit 102 in the received image, the miss scan detection module 310 may determine that the localized, outlined product moved across the flatbed area 104 of the self-checkout unit 504. Otherwise, the miss scan detection module 310 may determine that the localized, outlined product did not move across the flatbed area 104 of the self-checkout unit 504

The example operation 504 may proceed to example operation 506 if the miss scan determination module 310 makes a determination that the localized, outlined product did not move across the flatbed area 104 of the self-checkout area 102 as outlined above. Alternatively, the example operation 504 may proceed to example operation 508 if the miss scan determination module 310 makes a determination that the localized, outlined product did move across the flatbed area 104 of the self-checkout area 102 as outlined above.

In example operation 506, upon determining that the localized, outlined product did not move across the flatbed area 104 of the self-checkout area 102 in a direction extending from the basket area 118 towards the bagging area 120 in the one or more images, the miss scan determination module 310 may determine that no scanning action was performed by the user. If so, the miss scan determination module 310 may complete the analysis of the scanning event and continue with the next scanning event by analyzing the next set of one or more images associated with the next scanning event using example method 500.

In example operation 508, upon determining that the localized, outlined product did move across the flatbed area 104 of the self-checkout area 102 in a direction extending from the basket area 118 towards the bagging area 120 in the one or more images, the miss scan determination module 310 may determine that a scanning action was performed by the user. If so, the miss scan determination module 310 may proceed with example operations 510-518 to further determine if there was in fact a miss scan theft incident.

In example operation 510, the miss scan determination module 310 may estimate the time at which the scanning action was performed. For example, the miss scan determination module 310 may use the time stamp values associated with the one or more images to estimate a time or a time interval period during which the localized, outlined product was positioned adjacent or on top of the flatbed area 104. Since the one or more scanning devices 106 are positioned adjacent to or integrated into the flatbed area 104, any scanning of the product is likely to happen when the product is adjacent to the one or more scanning devices 106. Thus, the scanning action may be estimated to have happened when the product is adjacent or over the flatbed area 104 and the time or time interval during which the localized, outline product is adjacent or on top of the flatbed area 104 may be estimated as the time at which the scanning action is likely to have been performed by the user.

In example operation 512, the miss scan determination module 310 may retrieve the transaction data for the estimated time interval from the POS terminal 112. For example, the miss scan detection module 310 may retrieve transaction data, as recorded by the POS terminal 112, for the time interval, as estimated in operation 510, for when the product was likely scanned at the self-checkout unit 102 by the user, the miss scan may retrieve transaction data as recorded by the POS terminal 112. In some examples, the miss scan detection module 310 may retrieve data additional transaction data for time intervals surrounding the estimated time interval as well.

In example operation 514, the miss scan determination module 310 may determine whether a checkout transaction for a product was present within the transaction data retrieved for the estimated time in operation 512. The presence of check out transaction, as captured by the one or more scanning devices 106 and recorded by the POS terminal 112, may indicate that a product was indeed scanned at a time close to the time of the scan action as estimated in operation 510.

As such, the example operation 514 may proceed to example operation 516 if the miss scan detection module 310 determines that a checkout transaction was not present on the transaction data retrieved from the POS terminal 112 for the estimated time interval. Alternatively, the example operation 514 may proceed to example operation 518 if the miss scan detection module 310 determines that a checkout transaction was present on the transaction data retrieved from the POS terminal 112 for the estimated time interval.

In example operation 516, upon determining that the checkout transaction was not present on the transaction data retrieved from the POS terminal 112 for the estimated time interval, the miss scan determination module 310 may determine that a miss scan theft may have occurred. Upon determining that a miss scan theft may have occurred, the miss scan detection module 310 may transmit a message to a retail store employee raising a flag that a potential miss scan theft may have occurred. The message transmitted by the miss scan detection module 310 may include details associated with the transaction, such as one or more of: the checkout lane identifier, the time at which the transaction occurred, the corresponding images, etc. Thus, the store employee.

In example operation 518, upon determining that a checkout transaction was in fact present on the transaction data retrieved from the POS terminal 112 for the estimated time interval, the miss scan determination module 310 may determine that no miss scan theft occurred and may complete the analysis of the scanning event and continue with the next scanning event by analyzing the next set of one or more images associated with the next scanning event using example method 500.

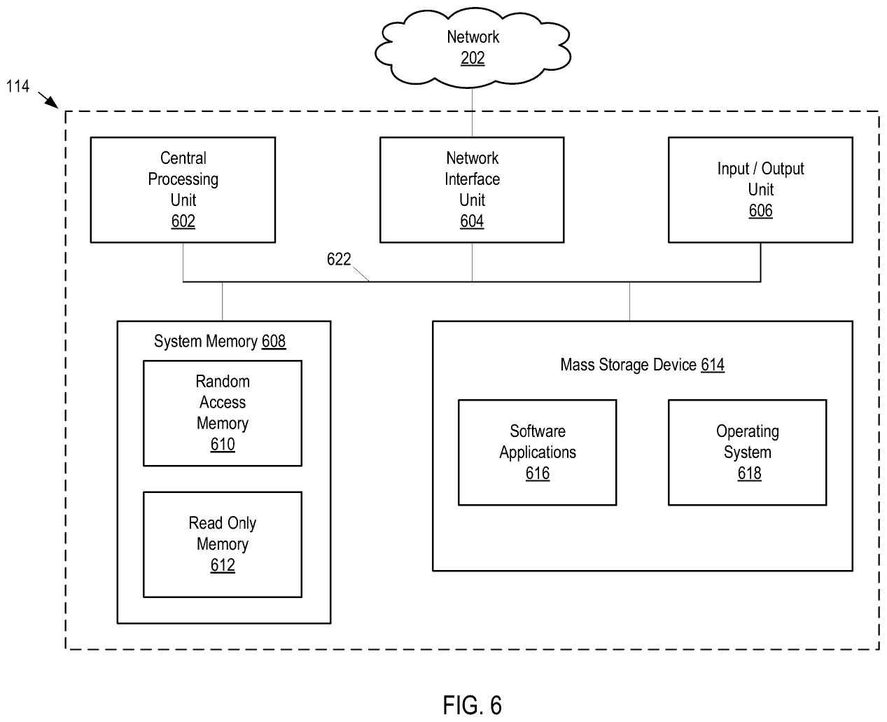

FIG. 6 illustrates example physical components of the computing device of FIGS. 1-2. As illustrated in the example of FIG. 6, the computing device 114 includes at least one central processing unit (“CPU”) 602, a system memory 608, and a system bus 622 that couples the system memory 608 to the CPU 602. The system memory 608 includes a random-access memory (“RAM”) 610 and a read-only memory (“ROM”) 612. A basic input/output system that contains the basic routines that help to transfer information between elements within the computing device 114, such as during startup, is stored in the ROM 612. The computing device 114 further includes a mass storage device 614. The mass storage device 614 is able to store software instructions and data 616 associated with software applications 616. Some or all of the components of the computing device 114 can also be included in user electronic computing device 104.

The mass storage device 614 is connected to the CPU 602 through a mass storage controller (not shown) connected to the system bus 622. The mass storage device 614 and its associated computer-readable data storage media provide non-volatile, non-transitory storage for the computing device 114. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 114.

According to various embodiments of the invention, the computing device 114 may operate in a networked environment using logical connections to remote network devices through the network 202, such as a wireless network, the Internet, or another type of network. The computing device 114 may connect to the network 202 through a network interface unit 604 connected to the system bus 622. It should be appreciated that the network interface unit 604 may also be utilized to connect to other types of networks and remote computing systems. The computing device 114 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the computing device 114 can store software instructions and data associated with software applications 616. The software instructions include an operating system 618 suitable for controlling the operation of the computing device 114. The mass storage device 614 and/or the RAM 610 also store software instructions, that when executed by the CPU 602, cause the computing device 114 to provide the functionality of the computing device 114 discussed in this document. For example, the mass storage device 614 and/or the RAM 610 can store software instructions that, when executed by the CPU 602, cause the computing device 114 to display received data on the display screen of the computing device 114.

What is claimed is:

1. A method to localize a product within one or more images, the method comprising:
receiving the one or more images from an imaging device;
identifying one or more background objects and one or more foreground objects within each of the one or more images using a background detection learning model;
identifying one or more body parts within the one or more foreground objects within each of the one or more images using a trained body part segmentation model;
identifying pixels associated with the product within each of the one or more images by segmenting out the one or more background objects and the one or more body parts from each of the one or more images; and
creating a localized product within each of the one or more image by enclosing the pixels associated with the product within each of the one or more images with an outline.

2. The method of claim 1, wherein all objects within each of the one or more images that are not identified to be the one or more background image by the background detection learning model are determined to be the one or more foreground objects.

3. The method of claim 1, wherein the one or more images are captured by the imaging device are of a user checking out a product at a self-checkout unit within a retail store.

4. The method of claim 3, further comprising:
determining whether the user is performing a scanning action;
upon determining that the user is performing the scanning action, estimating a time interval at which the user performs the scanning action;
retrieving transaction data for the time interval from a point-of-sale terminal;
determining whether a checkout transaction was recorded among the transaction data for the time interval; and
upon determining that the checkout transaction was not recorded among the transaction data for the time interval, determining that a miss scan theft occurred.

5. The method of claim 4, wherein determining whether the user is performing the scanning action includes:
determining whether a position of the localized product among the one or more images moves from one side of a flatbed area of the self-checkout unit to another side of the flatbed area the self-checkout unit.

6. The method of claim 4, wherein estimating the time interval at which the user performs the scanning action includes:
identifying a set of images among the one or more images where the localized product is positioned over a flatbed area of the self-checkout unit;
determining timestamps associated with the set of images; and
determining a time interval that spans across the timestamps.

7. The method of claim 4, further comprising:
sending a notification to an employee of the retail store alerting the employee that the miss scan theft occurred.

9. The method of claim 1, wherein the one or more background objects include static objects within each of the one or more images that do not change position over a period of time and the one or more foreground objects are all objects within the one or more images that are not the one or more background objects.

8. The method of claim 1, wherein the background detection learning model is a Mixture of Gaussians 2 (MOG2) model and the trained body part segmentation model is a video object segmentation (VOS) model.

10. A system to localize a product within one or more images, the system comprising:
an imaging device;
a computing system comprising:
a processor;
a memory communicatively connected to the processor which stores program instructions executable by the processor, wherein, when executed the program instructions cause the system to:
receive the one or more images from the imaging device;
identify one or more background objects and one or more foreground objects within each of the one or more images using a background detection learning model;
identify one or more body parts within the one or more foreground objects within each of the one or more images using a trained body part segmentation model;
identify pixels associated with the product within each of the one or more images by segmenting out the one or more background objects and the one or more body parts from each of the one or more images; and
create a localized product within each of the one or more image by enclosing the pixels associated with the product within each of the one or more images with an outline.

11. The system of claim 10, wherein segmenting out the one or more background objects and the one or more body parts from an image includes selecting all pixels within the image that are not identified as belonging to one of the one or more background objects or the one or more body parts.

12. The system of claim 10, wherein the one or more background objects include static objects within each of the one or more images that do not change position over a period of time and the one or more foreground objects are all objects within the one or more images that are not the one or more background objects.

13. The system of claim 10, wherein the one or more images are captured by the imaging device are of a user checking out a product at a self-checkout unit within a retail store.

14. The system of claim 13, wherein when executed, the program instructions further cause the system to:
determine whether the user is performing a scanning action;
upon determining that the user is performing the scanning action, estimate a time interval at which the user performs the scanning action;
retrieve transaction data for the time interval from a point-of-sale terminal associated with the self-checkout unit;
determine whether a checkout transaction was recorded among the transaction data for the time interval; and
upon determining that the checkout transaction was not recorded among the transaction data for the time interval, determine that a miss scan theft occurred.

15. The system of claim 14, wherein to determine whether the user is performing the scanning action includes to:
determine whether a position of the localized product among the one or more images moves from one side of a flatbed area of the self-checkout unit to another side of the flatbed area the self-checkout unit.

16. The system of claim 14, wherein to estimate the time interval at which the user performs the scanning action includes to:
identify a set of images among the one or more images where the localized product is positioned over a flatbed area of the self-checkout unit;
determine timestamps associated with the set of images; and
determine a time interval that spans across the timestamps.

17. The system of claim 14, wherein when executed, the program instructions further cause the system to:
send a notification to an employee of the retail store alerting the employee that the miss scan theft occurred.

18. The system of claim 10, wherein the background detection learning model is a Mixture of Gaussians 2 (MOG2) model and the trained body part segmentation model is a video object segmentation (VOS) model.

19. A system to detect miss scan theft, the system comprising:
a self-checkout unit comprising:
a flatbed area;
a point-of-sale terminal;
an imaging device; and
a computing system comprising:
a processor;
a memory communicatively connected to the processor which stores program instructions executable by the processor, wherein, when executed the program instructions cause the system to:
receive one or more images from the imaging device;
identify one or more background objects and one or more foreground objects within each of the one or more images using a background detection learning model;
identify one or more body parts within the one or more foreground objects within each of the one or more images using a trained body part segmentation model;
identify pixels associated with a product within each of the one or more images by segmenting out the one or more background objects and the one or more body parts from each of the one or more images;
create a localized product within each of the one or more image by enclosing the pixels associated with the product within each of the one or more images with an outline;
determine whether a user is performing a scanning action at the self-checkout unit by determining whether a position of the localized product among the one or more images moves from one side of the flatbed area of the self-checkout unit to another side of the flatbed area the self-checkout unit;
upon determining that the user is performing the scanning action, estimate a time interval at which the user performs the scanning action;
retrieve transaction data for the time interval from the point-of-sale terminal associated;
determine whether a checkout transaction was recorded among the transaction data for the time interval; and
upon determining that the checkout transaction was not recorded among the transaction data for the time interval, determine that a miss scan theft occurred.

20. The system of claim 19, wherein when executed, the program instructions further cause the system to:
identify one or more of common objects within the one or more foreground objects within each of the one or more images using an object segmentation model, wherein the one or more common objects include one or more of: at least a portion of a shopping basket, at least a portion of a shopping cart, a cellular telephone, a purse, a wallet, or at least a portion of clothing associated with the user; and
segment out the one or more common objects when identifying the pixels associated with the product within each of the one or more images.
